(19) United States
(12) Patent Application Publication
(10) Pub. No.: US 2004/0013482 A1
(43) Pub. Date: Jan. 22, 2004

(54) Tubular drill

(76) Inventors: Thierry Gillet, Brussels (BE); Theodore Holsteyns, Helchteren (BE)

Correspondence Address: BROWDY AND NEIMARK, P.L.L.C., 624 NINTH STREET, NW, SUITE 300, WASHINGTON, DC, 20001-5303, US

(21) Appl. No.: 10/220,599

(22) PCT Filed: Mar. 1, 2001
(86) PCT No.: PCT/BE01/00032

(30) Foreign Application Priority Data
Mar. 1, 2000 (BE) 2000/0167

(51) Int. Cl. B23B 51/04

(52) U.S. Cl. 408/204

(57) ABSTRACT

The invention concerns a tubular drill and a method to manufacture such a drill, whereby one of the far ends (2) is provided with a cutting edge (3), preferably containing diamonds, and the other far end (4) displays fastening means to mount the drill on a drive mechanism, such as a tooling machine, whereby said fastening means mainly display an almost radial deformation (11) of said other far end (4), via which the drill can be mounted on said drive mechanism, either or not by means of a removable coupler (18).

The invention concerns a tubular drill, one of the far ends of which is provided with a cutting edge, preferably containing diamonds, and the other far end of which has fastening means to mount the drill on a drive mechanism, such as a tooling machine.

In certain existing drills of this type is provided a coupler on said other far end, which is fixed onto it, for example by means of welding, gluing, soldering or by means of a mechanical fastening, in order to allow these drills to rotate around their axes and simultaneously exert an axial force.

Such drills require the coupler to be mounted very precisely, among others because this coupler must be accurately centralised and aligned in relation to the tubular part of the drills, such that this is a very time-consuming and costly operation.

With another type of existing drills, the coupler is screwed on the far end concerned of the tubular part of the drills.

In order to be able to resist the force exerted on this tubular part in a sufficient manner, a reinforcement must be provided on said far end which is thus equipped with internal or outside thread.

This reinforcement is obtained by making use of a tubular part with a relatively thick wall or by providing a ring-shaped thickening on the outside of the tubular part at the height of said far end thereof.

This other type of drills thus require more raw material and possibly additional processing in order to obtain said reinforcement, which makes them relatively costly as well.

The invention mainly aims to provide a tubular drill which makes it possible to remedy said disadvantages of the known drills, among others by considerably simplifying their production, however without harming the advantages offered by such drills.

Thus, the fastening means of the drill according to the invention are mainly formed of an almost radial deformation of the far end of the tubular part of the drill which must be directed towards the drive mechanism, a deformation in which is provided for example an opening which is coaxial with the tubular part, via which the drill can be mounted on said drive mechanism, either or not by means of a removable connecting piece, in particular a coupler.

According to a first special embodiment of the invention, said deformation has a cylindrical thickening on said other far end around the above-mentioned opening, whereby this thickening is provided with internal or outside thread onto which can be fastened a thread connection of the above-mentioned tooling machine or connecting piece.

According to a second special embodiment of the invention, said other far end has a funnel-shaped widening with which the drill must be mounted on a drive mechanism by means of a removable coupler.

The invention also concerns a method for manufacturing a tubular drill, one of the far ends of which is provided with a cutting edge, and the other far end of which has fastening means to mount the drill on a drive mechanism.

The method is characterised in that a cylindrical tube is taken as a basis, one of the far ends of which is provided with a cutting edge, and the other far end of which, opposite to the far end having a cutting edge, is subjected to a radial deformation, such that a cylindrical thickening and/or widening is created on this other far end onto which the fastening means are provided.

Other particularities and advantages of the invention will become clear from the following description of some particular embodiments of the invention; this description is given as an example only and does not limit the scope of the invention in any way; in the following description, the reference figures refer to the accompanying drawings.

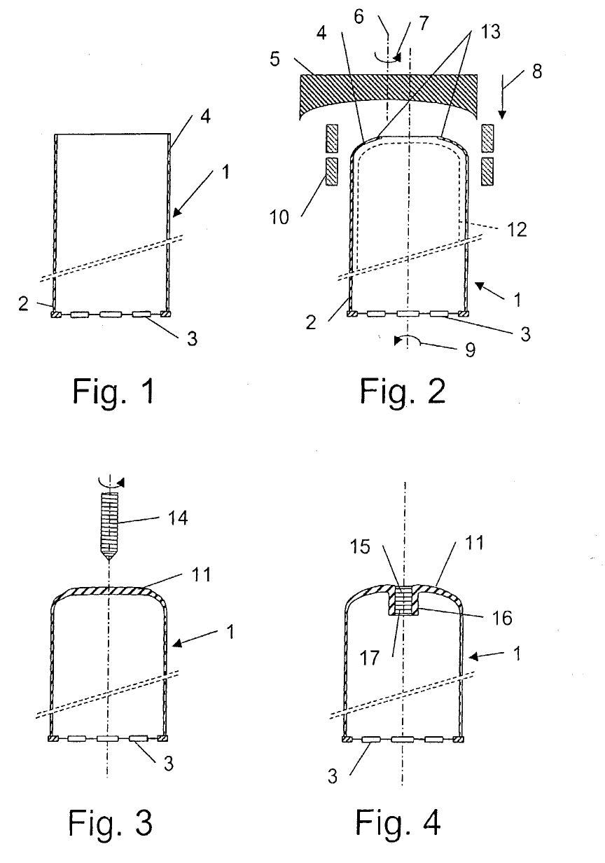

FIG. 1 is a schematic axial section of a tubular drill of which the far end which must be fixed on a drive mechanism has not been deformed yet.

FIGS. 2 and 3 represent a schematic axial section illustrating two consecutive stages in the manufacturing process of a drill according to a first embodiment of the invention, starting from the tubular shape according to FIG. 1.

FIG. 4 is a schematic axial section of this first embodiment.

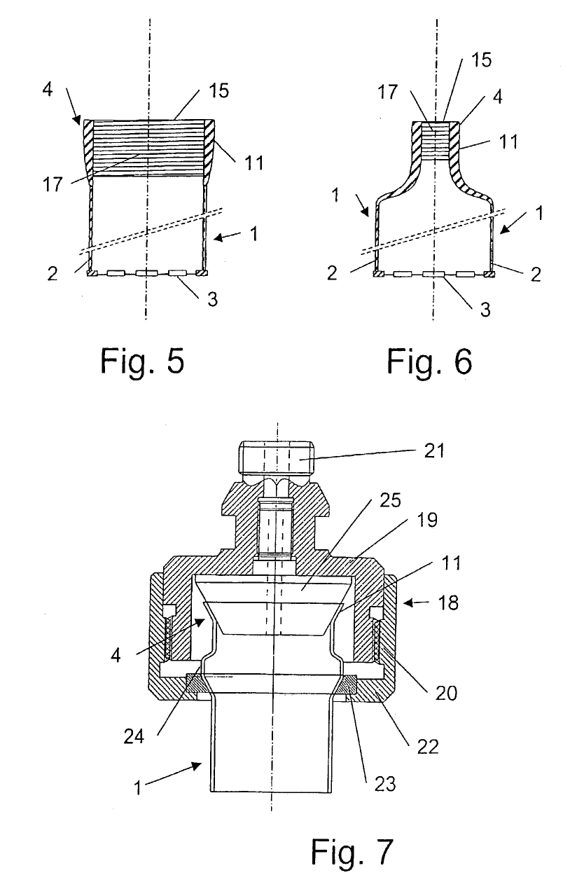

FIG. 5 is a schematic axial section of a first variant of this first embodiment.

FIG. 6 is a schematic axial section of a second variant on said first embodiment.

FIG. 7 represents an axial section to a larger scale of a drill according to a second embodiment with a suitable coupler.

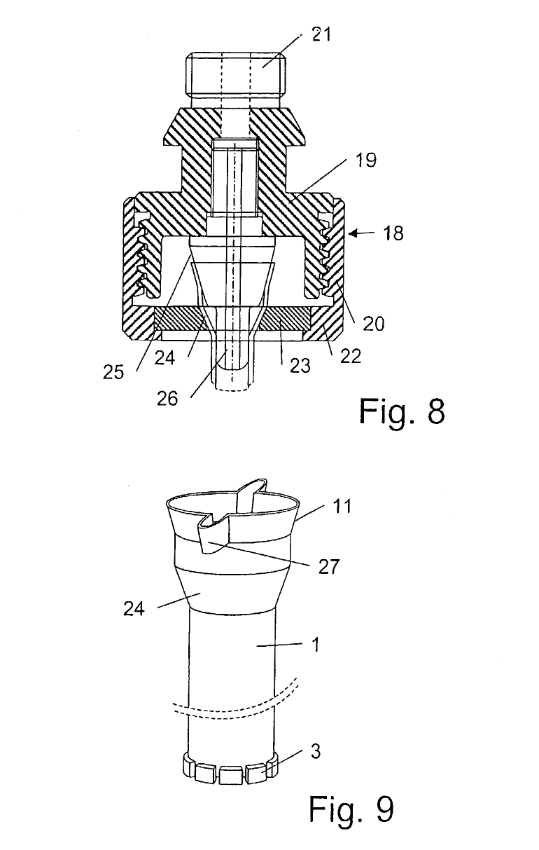

FIG. 8 represents, also to a larger scale, an axial section of a drill according to a first variant on this second embodiment of the invention with a suitable coupler.

FIG. 9 shows a view in perspective with a partial section of a second variant on this second embodiment.

In the different figures, the same reference figures refer to the same or analogous elements.

Generally speaking, the present invention concerns a method for manufacturing a tubular drill, as well as a tubular drill, one of the far ends of which is provided with a cutting edge, preferably containing diamonds, and the other far end of which has fastening means to mount the drill on a drive mechanism, in particular a tooling machine, such as a drilling machine, whereby these fastening means are obtained by reinforcing the other far end by providing it with a certain deformation, and by providing, in the thus deformed part, a fastening element which is coaxial with the drill, via which this drill can be mounted on the drive mechanism.

Thus, according to the invention, the necessary reinforcement of this other far end of the drill is obtained in a very simple manner, without adding any material or an extra part, to absorb the forces onto which this other end is subjected by the drive mechanism.

FIGS. 1 to 4 schematically represent the successive stages of the manufacturing process of a drill according to a first embodiment.

As was represented in FIG. 1, a short length of tubing 1 made of suitable metal is taken as a basis, one far end 2 of which is for example already provided with a cutting edge 3. This cutting edge 3 may for example consist of a continuous diamond crown or, as represented in FIG. 1, of successive diamond segments.

In a first stage, as illustrated in FIG. 2, the opposite far end 4 is subjected to a certain controlled deformation, whereby use is made of a designing or forging tool 5 which is rotated around its axis 6 in an eccentric manner in relation to the short length of tubing 1, as indicated by arrow 7, whereas an axial pressure force is simultaneously exerted on the length of tubing 1, as indicated by arrow 8.

Such a tool has for example been described and represented in German patent 4.431.517-C1.

Preferably, the length of tubing 1 also undergoes a rotation opposite to that of the tool 5, as indicated by arrow 9.

Moreover, during said designing, the far end 2 is heated by means of induction. The induction coils 10 were hereby schematically represented in FIG. 2.

In this manner, the far end 4 is gradually bent inwardly until its edges melt together, thanks to the induction heating, so as to form a closed dome 11, as is represented in FIG. 3.

Thanks to an upsetting effect is obtained a certain thickening of the thus created dome-shaped wall 11. By making use of an arbour 12, the deformation of this far end 4 can be kept more or less under control, and the free edge 13 of the far end 4 can be prevented from bending down, which would hinder the creation of a closed dome 11.

FIG. 3 illustrates a second stage, whereby a central opening 15 is obtained by means of a liquid drill 14, while a bush 16 is simultaneously formed which is coaxial to the short length of tubing 1, as represented in FIG. 4. Finally, screw thread 17 is tapped or rolled in this bush 16.

However, if no use is made of an arbour 12, the free edge 13 of the far end 14 will be bent down, as already mentioned above, and in a certain way, the same result will be obtained as with liquid drilling, namely a central opening 15 with a bush 16 being formed on the inside of said dome 11.

By means of this opening 15 and the bush 16 connecting onto it with internal screw thread, the drill can be fixed in a very simple manner on a drive mechanism which is not represented in the figures. Thanks to the above-mentioned upsetting effect, which is further stressed by any possible liquid drilling, is obtained a bush 16 with a relatively important wall thickness and thus with sufficient rigidity to absorb the force exerted on it during the drilling.

FIG. 5 represents an axial section of a first variant on the above-described first embodiment represented in FIG. 4.

This first variant is different from the first embodiment in that the reinforcement of the far end 4 is obtained by heating the latter until it has become almost mouldable and by subjecting it to an axial pressure force, such that a thickening 11 of the wall of this far end 4 is obtained by upsetting it, as is illustrated in FIG. 5. The next step then consists in tapping screw thread 17 in this far end 4. This can possibly be done in two operations. During a first operation, the diameter in the far end 4 is determined by means of a drill, whereas the screw thread is tapped during a following operation. Thus can be made sure that this diameter is at least as large as the diameter of the short length of tubing 1 itself, in order to make it possible for the core formed during the drilling to be removed via this far end 4 in a simple manner.

Possibly, the screw thread 17 can be provided on the outer wall of the thickening 11.

FIG. 6 relates to a second variant of the above-described first embodiment.

It is different from the first variant in that the reinforcement of the far end 4 is obtained by applying a rolling technique known as such. In this manner is obtained a relatively thick-walled neck-shaped constriction 11 of the far end 4.

This technique can be applied for example on a short length of tubing 1 with a relatively large diameter.

In this variant can be applied internal thread, as represented in FIG. 6, as well as outside thread on said constriction. If for example outside thread is provided, the far end 4 can be entirely consolidated, so that there is no opening any more. FIG. 7 relates to a second embodiment of the drill according to the invention. It is particularly related to a drill having a diameter of at least 20 mm.

In this second embodiment, the far end 4 has a funnel-shaped widening 11 with which the drill has to be mounted on a drive mechanism by means of a removable coupler 18.

This coupler 18 consists of two parts 19 and 20 screwed onto one another.

The part 19, which has to be mounted on a spindle of a drive mechanism which is not represented here by means of a nut 21, comprises a tapered element 25 against which the widening 11 of the far end 4 of the drill is fixed with screws by means of the part 20.

To this end, this part 20, which is slid over the short length of tubing 1, has an inwardly directed edge 22, upon which is placed a ring 23, which meshes behind a ring-shaped collar 24, provided at a certain distance from said widening 11 on the length of tubing 1 of the drill.

This widening 11 and the collar 24 can be formed simultaneously by applying what is called the rolling technique.

FIG. 8 represents a variant which is different from the embodiment according to FIG. 7 in that the ring 23 which rests on the inwardly directed edge 22 presses directly onto the bottom side of the widening 11. Possibly, the drill can be supported on the inside by means of an arbour 26 which is fixed on the part 19 of the coupler 18.

This variant is particularly related to drills with a relatively small diameter, namely from 10 to 35 mm at the most.

In some cases it may be useful to provide for example two diametrically opposed notches, which are not represented here and which are designed to fit onto a corresponding protrusion of the drive mechanism of the coupler 18, in the widening 11 of this second embodiment and the variant thereof.

In other cases, as is illustrated by FIG. 9, shoulders or protrusions 27 instead of recesses or notches can be provided on the outside of the widening 11. These can be obtained in one single step by means of hot deformation or forging.

To further illustrate the invention, the following two examples are given as practical embodiments of the invention.

### EXAMPLE I

This example relates to the above-described first embodiment represented in FIGS. 1 to 4.

A tube having an outer diameter of 66 mm and an inner diameter of 63 mm, and with a length of 322 mm made of soft steel (type St37 or Ck15-DIN standards) is equipped as follows by a machine when caulked:

The tube (1), caught in a clamping system, rotates at a speed of 1500 RPM. The other far end 4 stays out of the clamping zone and is heated up to a temperature of some 1250-1300° C. by means of an induction coil (10) or a gas burner. Next, the heat source is quickly removed and a steel shell 5 is immediately provided against this far end 4 with a force which gradually increases up to 1.5 ton. As the shell 5 rotates eccentrically, the system allows for material to flow from the tube through a plastic deformation until the completion of the sealing. The total cycle time amounts to 12 to 15 seconds. In order to prevent the tube 1 from tearing or staying open, a profiled arbour 12 is provided in the tube 1 via the first far end 2, and one has to make sure that this arbour 12 supports the deformation of the other far end 4 until the sealing has been completed. In this case, the arbour stays at a distance of some 6 mm from the shell 5, such that the wall thickness of the thus created lid 11 also amounts to 6 mm. After the upsetting, the tubular length is about 304 mm. The liquid drilling of the central opening on the other far end 4 is carried out by means of a ceramic point or drill 14 having a diameter of 18 mm. The tube, which is still being clamped, turns around its axis at a speed of 900 RPM. The ceramic point 14 is centrally provided against the lid 11. Due to the created friction, the temperature rises to some 900-1000° C. The applied pressure again deforms the material and provides for an opening 15 with again an upsetting effect of some 21 mm. The useful inner length of the tubular drill with is diamonds finally amounts to 280 mm.

### EXAMPLE II

This example refers to the above-described embodiment of the invention represented in FIG. 8.

A tube 1 with an outer diameter of 9 mm and an inner diameter of 7 mm with a similar composition St35 or St37 is deburred and deflashed on the other far end 4. The tube is clamped in a rotating machine, such as a lathe. A profiled ceramic point 14, represented with the required plot measurements in FIG. 8, is then provided against this other far end. The created frictions cause a temperature rise of some 900-1000° C. The exerted pressure of the ceramic point 14 deforms the tube 1 from the inside towards the outside. The total expansion amounts to 19 mm in diameter and has a conical shape. The cycle time amounts to some 10 seconds.

Naturally, the invention is not restricted to the above-described embodiments represented in the accompanying drawings; several variants are possible within the scope of the invention, among others as far as the deformation of the far end of the drill directed towards the drive mechanism is concerned.

In some cases, in order to obtain the drill according to the first embodiment, the first and second above-described steps can be carried out in a single operation.

1. Method for manufacturing a tubular drill, one of the far ends (2) of which is provided with a cutting edge (3), and the other far end (4) of which has fastening means to mount the drill on a drive mechanism, whereby a cylindrical tube (1) is taken as a basis, one of the far ends (2) of which is provided with a cutting edge (3), the method being characterized in that the other far end (4) of this tube (1) opposite to the far end with a cutting edge (3) is subjected to a radial deformation during rotation of the tube (1), such that a thickening and/or widening (1) is created on this other far end (4) onto which the fastening means are provided.

2. Method according to claim 1 characterized in that said thickening (11) is provided with internal or outside thread (17), onto which can be fastened a screw thread connection of said drive mechanism.

3. Method according to claim 1 or 2, characterized in that a radial, neck-shaped, thick-walled constriction (11) is provided on said other far end (4) of the cylindrical tube (1) by applying the rolling technique known as such.

4. Method according to claim 1 of 2, characterized in that said other far end (4) is subjected to a dome-shaped deformation wit h a central thickening by applying the upsetting technique known as such, whereby, during the upsetting, the thus created deformation of the other far end (4) is supported by means of an arbor (12), and a central opening (15) is subsequently provided in this thickening, for example by means of liquid drilling.

5. Method according to claim 4, characterized in that a central thickening is formed which consists of a ring-shaped bulge or bush (16) directed towards the cutting edge (3), which delimits said opening (15) and in which is provided screw thread (17) for fastening a drive mechanism.

6. Method according to claim 1, characterized in that said other far end (4) of the cylindrical tube (1) is subjected to such a conical deformation or widening (11) that this other far end (4) can be mounted on a drive mechanism by means of a removable coupler (18).

7. Method according to claim 6, characterized in that said other far end (4) is provided with one or several notches, protrusions (27) respectively, which are designed to be attached on a protrusion, notch respectively, of the drive mechanism such that they practically fit.

8. Tubular drill, one of the far ends (2) of which is provided with a cutting edge (3), preferably containing diamonds, and the other far end (4) of which has fastening means to mount the drill on a drive mechanism, such as a tooling machine, characterized in that said fastening means mainly display an almost radial deformation (11) of said other far end (4) via which the drill can be mounted on the abovementioned drive mechanism, either or not by means of a removable coupler and whereby (18) sad other far end (4) has one or several notches, protrusions (27) respectively, which are designed to be attached on a protrusion, notch respectively of the drive mechanism such that they practically fit.
